(19) United States
(12) Patent Application Publication
(10) Pub. No.: US 2026/0038716 A1
(43) Pub. Date: Feb. 5, 2026

(54) APPARATUS FOR NOTCHING ELECTRODE SHEET

(71) Applicant: SAMSUNG SDI CO., LTD., Yongin-si (KR)

(72) Inventor: Kyuchul CHOI, Yongin-si (KR)

(21) Appl. No.: 19/173,043

(22) Filed: Apr. 8, 2025

(30) Foreign Application Priority Data
Jul. 30, 2024 (KR) 10-2024-0101297

(51) Int. Cl. H01B 13/00; B23K 26/08; B23K 26/142; B23K 26/362; B23K 101/38; H01M 4/04

(52) U.S. Cl. CPC H01B 13/003; B23K 26/0846; B23K 26/142; B23K 26/362; H01B 13/0003; B23K 2101/38; H01M 4/04

(57) ABSTRACT

An apparatus for notching an electrode sheet, the apparatus may include a transport part configured to transport an electrode sheet, and a laser part configured to include a plurality of laser parts disposed on the transport part and to irradiate a laser beam to notch the electrode sheet so as to form electrode tabs, wherein the laser parts may be spaced apart from each other in a moving direction of the electrode sheet, and each of the laser parts may irradiate a laser beam onto a certain area of the electrode sheet in a same pattern.

### CROSS-REFERENCE TO RELATED APPLICATION

The present application claims priority to and the benefit of Korean Application No. 10-2024-0101297, filed on Jul. 30, 2024, in the Korean Intellectual Property Office, the entire disclosure of which is incorporated by reference herein.

### BACKGROUND

### Field

Aspects of embodiments of the present disclosure relate to an apparatus for notching an electrode sheet.

### Description of the Related Art

Unlike primary batteries that are not designed to be recharged, secondary (or rechargeable) batteries are batteries that are designed to be discharged and recharged. Low-capacity secondary batteries are used in portable small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the electrode assembly, and electrode terminals connected to the electrode assembly.

The electrode assembly includes a structure in which electrodes and separators are alternately stacked. The electrodes may be manufactured by cutting an electrode sheet to a small width according to the specifications of the cell and then irradiating the electrode sheet with a laser beam to notch the sheet and thereby form an electrode tab. In a case where the electrode sheet is notched by a laser beam, there can be a problem of quality deterioration due to changes in the surface of the electrode sheet caused by heat of the laser beam. In addition, when the processing is performed using a low-energy laser beam, damage caused by heat may be reduced, but processing stability may be deteriorated.

The above information disclosed in this Background section is for enhancement of understanding of the background of the present disclosure, and therefore, it may contain information that does not constitute related (or prior) art.

### SUMMARY

Aspects of embodiments of the present disclosure provide an apparatus for notching an electrode sheet so as to solve the above-described problems.

These and other aspects and features of the present disclosure will be described in or will be apparent from the following description of embodiments of the present disclosure.

According to one or more embodiments of the present disclosure, an apparatus is provided for notching an electrode sheet. The apparatus may include a transport assembly configured to transport an electrode sheet, and a laser assembly including a plurality of laser parts disposed adjacent to the transport part and to configured to irradiate laser beams to notch the electrode sheet to thereby form electrode tabs, wherein the laser parts may be spaced apart from each other in a moving direction that the transport assembly is configured to move the electrode sheet, and each of the laser parts may irradiate a laser beam onto a certain area of the electrode sheet in a pattern, with the patterns of the laser beams being the same.

In some embodiments, the laser parts may be configured to irradiate laser beams onto the moving electrode sheet to sequentially notch the electrode sheet in a thickness direction of the electrode sheet.

In some embodiments, the laser parts may include: a first laser part disposed upstream in the moving direction of the electrode sheet and configured to irradiate a laser beam onto the electrode sheet to form a notching pattern; a second laser part disposed downstream of the first laser part in the moving direction of the electrode sheet and configured to irradiate a laser beam onto the notching pattern to notch a portion of the electrode sheet in a thickness direction of the electrode sheet; and a third laser part disposed downstream of the second laser part in the moving direction of the electrode sheet and configured to irradiate a laser beam onto the notching pattern to form the electrode tabs.

In some embodiments, at least one of the first laser part, the second laser part, or the third laser part may be spaced at a different height from the electrode sheet than another of the first laser part, the second laser part, and the third laser part.

In some embodiments, each of the first laser part, the second laser part, and the third laser part is configured to irradiate a pulsed laser beam or a continuous wave laser beam.

In some embodiments, the electrode sheet may be formed by coating a first active material layer and a second active material layer on both sides of a metal substrate with a portion of the electrode sheet remaining uncoated may be formed, and the laser parts sequentially notch the first active material layer, the metal substrate, the uncoated portion, and the second active material layer.

In some embodiments, the first laser part is configured to form the notching pattern by irradiating a laser beam onto the first active material layer or the uncoated portion and the first active material layer.

In some embodiments, the second laser part is configured to irradiate a laser beam onto the notching pattern to notch the metal substrate and the uncoated portion after the first active material layer may be notched by the first laser part.

In some embodiments, the third laser part may be configured irradiate a laser beam onto the notching pattern to notch the second active material layer.

In some embodiments, the first laser part and the third laser part are configured to be positioned at a first height above the electrode sheet, and the second laser part is configured to be positioned a second height above the electrode sheet, with the second height being less than the first height.

In some embodiments, the first laser part and the third laser part are configured irradiate pulsed laser beams, and the second laser part is configured to irradiate a continuous wave laser beam.

In some embodiments, the laser unit may include: a base plate; and a vertical movement part provided on the base plate and configured to move each of the laser parts to adjust gaps between the laser parts and the electrode sheet.

In some embodiments, the laser unit may include a horizontal movement part provided between the vertical movement part and the laser parts, the horizontal movement part being configured to move the laser parts in a direction parallel to the moving direction of the electrode sheet.

In some embodiments, the laser unit may include a controller configured to control the horizontal movement part to move at least one of the laser parts at a same speed as a moving speed of the electrode sheet.

In some embodiments, the transport assembly may include: a lower transport part configured to support a lower side of the electrode sheet; and an upper transport part configured to support an upper side of the electrode sheet.

In some embodiments, the transport assembly may include: a conveying belt having a plurality of through-holes formed therein; a driving roller configured to rotate the conveying belt; a first cover plate and a second cover plate disposed on opposite sides of the conveying belt and configured to seal an internal space of the conveying belt; and a vacuum pump connected to the first cover plate and configured to suck in air inside the conveying belt so as to absorb the electrode sheet to the conveying belt.

In some embodiments, the second cover plate may include a plurality of suction holes for sucking in spatter may be generated during the notching of the electrode sheet.

In some embodiments, the apparatus may further include: a spatter collection part disposed adjacent to the laser assembly and configured to suck in spatter generated during the notching of the electrode sheet; and a blower disposed adjacent to the laser assembly and configured to generate air flow to move the spatter generated during the notching of the electrode sheet to the spatter collection part.

In some embodiments, the apparatus may further include: a recovery tray disposed at a position facing the laser assembly and configured to recover scrap dropped during the notching of the electrode sheet; and a vacuum pump connected to the recovery tray and configured to provide suction force to the recovery tray.

In some embodiments, the apparatus may further include: a recovery belt that is disposed at a position facing the laser assembly and on which scrap generated during the notching of the electrode sheet may be received; a driving roller configured to rotate the recovery belt; a recovery tray configured to recover the scrap dropped from the recovery belt; and a vacuum pump connected to the recovery tray and configured to provide suction force to the recovery tray.

According to embodiments of the present disclosure, by irradiating an electrode sheet with a plurality of low-energy laser beams a plurality of times, processing stability may be improved while preventing damage to the electrode sheet caused by heat.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates an example of an apparatus for notching an electrode sheet according to some embodiments of the present disclosure.

FIG. 2 illustrates an example of a state in which an electrode sheet is notched by the apparatus for notching an electrode sheet according to some embodiments of the present disclosure.

FIG. 3 illustrates an example of a laser unit according to some embodiments of the present disclosure.

FIG. 4 illustrates an example of an operating state of an apparatus for notching an electrode sheet according to some embodiments of the present disclosure.

FIG. 5 illustrates an example of arrangement of a plurality of laser parts in an apparatus for notching an electrode sheet according to some embodiments of the present disclosure.

FIG. 6 illustrates an example of a state in which a laser part is moved in an apparatus for notching an electrode sheet according to some embodiments of the present disclosure.

FIG. 7 illustrates another example of a movement part in an apparatus for notching an electrode sheet according to some embodiments of the present disclosure.

FIG. 8 illustrates an example of vacuum absorption of an electrode sheet in a movement part according to some embodiments of the present disclosure.

FIG. 9 illustrates an example of suction of spatter in a movement part according to some embodiments of the present disclosure.

FIG. 10 illustrates an example of removing spatter in an apparatus for notching an electrode sheet according to some embodiments of the present disclosure.

FIG. 11 illustrates an example of recovering scrap in an apparatus for notching an electrode sheet according to some embodiments of the present disclosure.

FIG. 12 illustrates another example of recovering scrap in an apparatus for notching an electrode sheet according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (or under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

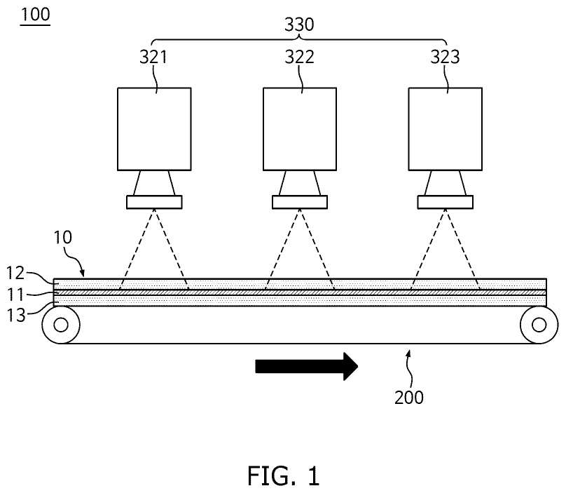

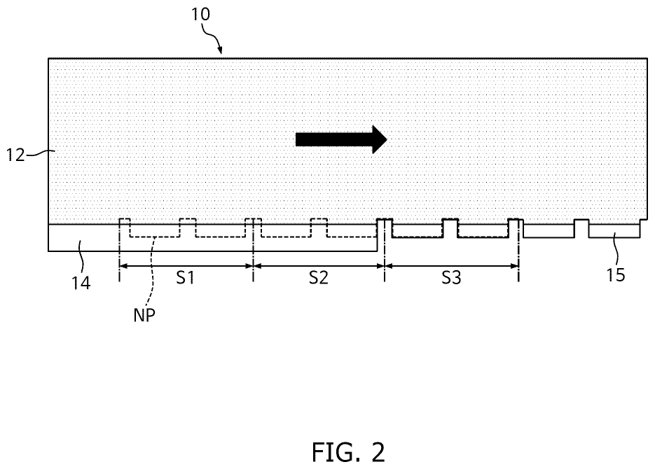

FIG. 1 illustrates an example of an apparatus for notching an electrode sheet according to some embodiments of the present disclosure, and FIG. 2 illustrates an example of a state in which an electrode sheet is notched by the apparatus for notching an electrode sheet according to some embodiments of the present disclosure.

Referring to FIGS. 1 and 2, an apparatus 100 for notching an electrode sheet according to some embodiments of the present disclosure may include a transport part 200 that transports an electrode sheet 10. The apparatus 100 may also include a laser unit 300 including a plurality of laser parts disposed above the transport part 200 and configured to irradiate a laser beam to notch the electrode sheet 10 so as to form electrode tabs 15.

According to some embodiments, instead of forming the electrode tabs 15 by irradiating the electrode sheet 10 with one application of a high-energy laser beam, the electrode tabs 15 may be formed by irradiating the same areas of the electrode sheet 100 a plurality of times with a relatively low-energy laser beam. With such a technique, processing stability may be improved while preventing the electrode sheet 10 from being damaged by heat of the laser beam.

To this end, a plurality of laser parts are spaced apart from each other in the moving direction of the electrode sheet 10, and each of the laser parts may irradiate a predetermined area of the electrode sheet 10 with the same pattern. For example, the laser parts may sequentially irradiate laser beams onto the same area on the moving electrode sheet 10 to sequentially notch the electrode sheet 10 in the thickness direction, thereby forming the electrode tabs 15.

In some embodiments, the laser parts may include a first laser part 321 disposed upstream in the moving direction of the electrode sheet 10 and configured to irradiate a laser beam onto the electrode sheet 10 to form a notching pattern NP, a second laser part 322 disposed adjacent to the first laser part 321 and configured to irradiate a laser beam onto the notching pattern NP to notch a portion of the electrode sheet 10 in the thickness direction, and a third laser part 323 disposed adjacent to the second laser part 322 and configured to irradiate a laser beam onto the notching pattern NP to form the electrode tabs 15.

The first laser part 321, which disposed upstream in the moving direction of the electrode sheet 10, irradiates a laser beam so that a notching pattern NP may be formed on the electrode sheet 10. The electrode sheet 10 is then moved so that the notching pattern NP is disposed below the second laser part 322, and the second laser part 322 may irradiate a laser beam onto the notching pattern NP to notch the notching pattern NP more deeply. The electrode sheet 10 is then moved so that the notching pattern NP is disposed below the third laser part 323, the third laser part 323 thirdly irradiates a laser beam onto the notching pattern NP to completely cut through the notching pattern NP, thereby forming the electrode tabs 15. A first notching area S1 that is notched by the first laser part 321 irradiating a laser beam, a second notching area S2 that is notched by the second laser part 322 irradiating a laser beam, and a third notching area S3 that is notched by the third laser part 323 irradiating a laser beam are connected to each other so that the electrode tabs 15 may be formed continuously.

In some embodiments, after a first notching pattern is formed in the first notching area S1, the first notching pattern may be moved to the second notching area S2. While the first notching pattern is notched in the second notching area S2, a second notching pattern may be formed in the first notching area S1. The first notching pattern may then be moved to the third notching area S3. While the first notching pattern is notched in the third notching area S3, the second notching pattern may be notched in the second notching area S2 and the third notching pattern may be formed in the first notching area S1.

While an embodiment having three laser parts is depicted in FIG. 1, other embodiments may be configured with two laser parts or four or more laser parts, for example, based on the thickness and material of the electrode sheet.

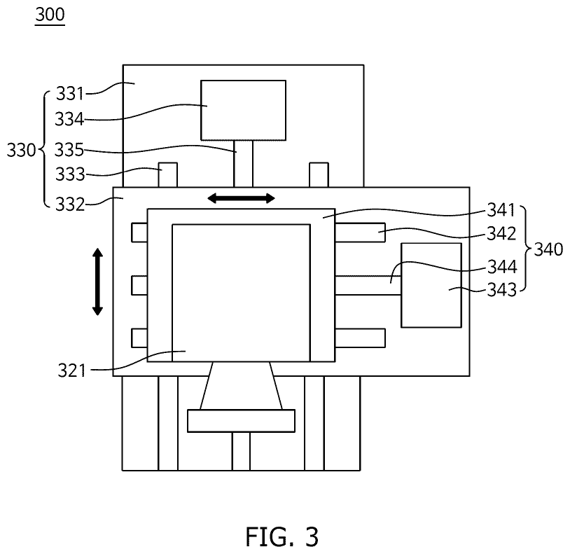

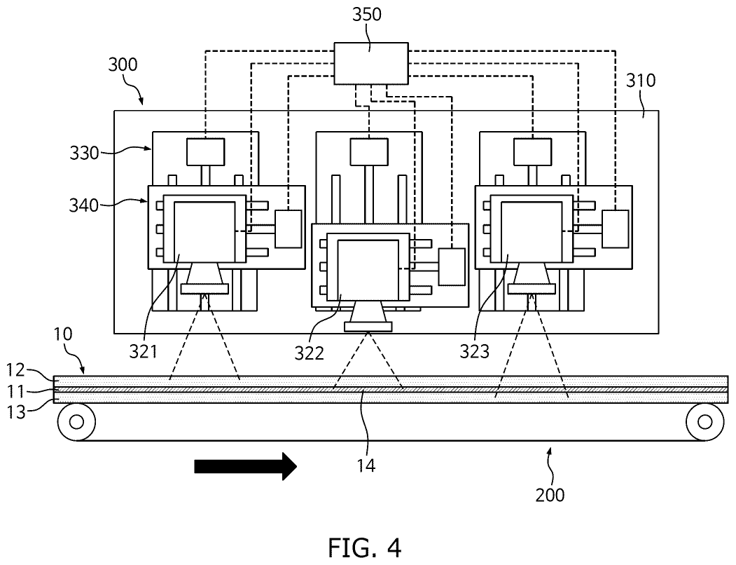

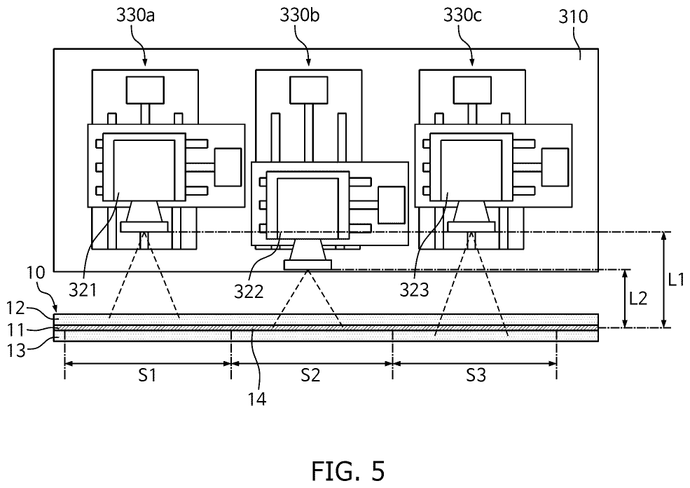

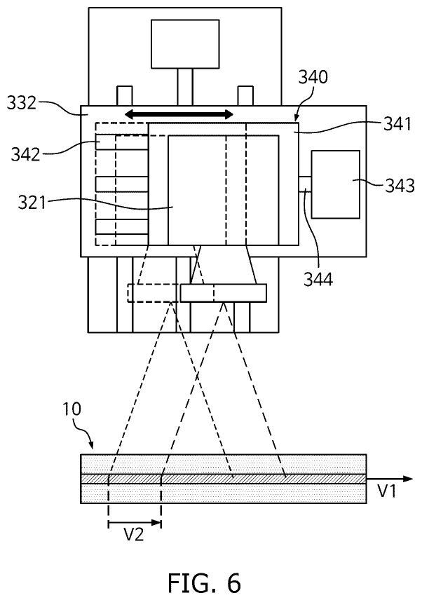

FIG. 3 illustrates an example of a laser unit according to some embodiments of the present disclosure, and FIG. 4 illustrates an example of an operating state of an apparatus for notching an electrode sheet according to some embodiments of the present disclosure. FIG. 5 illustrates an example of an arrangement of a plurality of laser parts in an apparatus for notching an electrode sheet according to some embodiments of the present disclosure, and FIG. 6 illustrates an example of a state in which a laser part is moved in an apparatus for notching an electrode sheet according to some embodiments of the present disclosure.

Referring to FIGS. 3 to 6, a laser unit 300 may include a base plate 310 and a vertical moving part 330 provided on the base plate 310 and configured to move a plurality of laser parts so as to adjust the spacing with respect to an electrode sheet 10.

Referring to FIG. 3, in some embodiments the vertical movement part 330 may include a coupling plate 331 coupled to the base plate 310, a guide rail 333 provided on the coupling plate 331. A vertical movement plate 332 moves along the guide rail 333 and a first laser part 321 is disposed on the vertical movement plate 332. A lead screw 335 is screwed to the vertical movement plate 332, and a driving motor 334 rotates the lead screw 335 to move the vertical movement plate 332. With this configuration, in a case where the driving motor 334 operates to rotate the lead screw 335, the vertical movement plate 332 may move linearly along the guide rail 333 to move the first laser part 321 in a direction perpendicular to the moving direction of the electrode sheet 10. Accordingly, the vertical movement part 330 may adjust the gap between the first laser part 321 and the electrode sheet 10. Of course, the configuration of the vertical movement part 330 is not limited to the depicted configuration, and the vertical movement part 330 may be configured in any form such as a linear actuator or an electric stage, as long as the vertical movement part 330 can move each of the first to third laser parts 321, 322, and 323 in a direction perpendicular to the moving direction of the electrode sheet 10.

Although only the vertical movement part 330 for moving the first laser part 321 is illustrated in FIG. 3, a vertical movement part 330a for moving the first laser part 321, a vertical movement part 330b for moving the second laser part 322, and a vertical movement part 330c for moving the third laser part 323 may be provided as illustrated in FIG. 5. With this configuration, at least one of the first laser part 321, the second laser part 322, or the third laser part 323 may positioned a different height from the electrode sheet 10 than the other parts.

The electrode sheet 10 may be manufactured by coating a first active material layer 12 and a second active material layer 13 on both sides of a metal substrate 11 so that an uncoated portion 14 is formed. The first to third laser parts 321, 322, and 323 may sequentially notch the first active material layer 12, the metal substrate 11, the uncoated portion 14, and the second active material layer 13.

In some embodiments, the first laser part 321 may form a notching pattern NP by irradiating a laser beam onto the first active material layer 12 or the uncoated portion 14 and the first active material layer 12. The second laser part 322 may irradiate a laser beam onto the notching pattern NP to notch the exposed metal substrate 11 and the uncoated portion 14 after the first active material layer 12 is notched. The third laser part 323 may irradiate a laser beam onto the notching pattern NP to notch the second active material layer 13, so that electrode tabs 15 may be finally formed.

A large amount of spatter may be generated during the process in which the first laser part 321 notches the first active material layer 12 and the third laser part 323 notches the second active material layer 13. Accordingly, the first laser part 321 and the third laser part 323 may be disposed so that a height L1 spaced apart from the electrode sheet 10 is higher than a height L2 at which the second laser part 322 is spaced apart from the electrode sheet 10. That is, the first laser part 321 and the third laser part 323 may be spaced the same distance from the electrode sheet 10, and the second laser part 322 may be a lower height above the electrode sheet 10 than the first laser part 321 and the third laser part 323. With this configuration, the first laser part 321 and the third laser part 323 irradiate a laser beam from a relatively long distance, and the second laser part 322 irradiates a laser beam from a relatively short distance. In this case, in order to irradiate the notching pattern with laser beams having the same intensity, a lens with a relatively long focal length may be used for the first laser part 321 and the third laser part 323, and a lens with a relatively short focal length may be used for the second laser part 322. For example, a lens having a focal length of 255 mm or more may be used for the first laser part 321 and the third laser part 323, and a lens having a focal length of about 160 mm may be used for the second laser part 322.

Each of the laser parts may irradiate a pulsed laser beam or a continuous wave laser beam. In some embodiments, the first laser part 321 and the third laser part 323 may irradiate a pulsed laser beam and the second laser part 322 may irradiate a continuous laser beam. The pulse duration may be affected in a case where the first laser part 321 and the third laser part 323 notch the active material layer. Therefore, the first laser part 321 and the third laser part 323 may irradiate a picosecond pulse duration laser. In a case where the second laser part 322 notches the metal substrate, it may be affected by the pulse. Therefore, the second laser part 322 may irradiate a continuous wave laser beam.

The laser unit 300 may include a horizontal movement part 340 provided between the vertical movement part 330 and the laser parts, with the horizontal movement part 340 moving each of the laser parts in a direction parallel to the moving direction of the electrode sheet 10. The laser unit may also include a controller 350 that controls the horizontal movement part 340 to move at least one of the laser parts at the same speed as the moving speed of the electrode sheet 10.

In some embodiments, the horizontal movement part 340 may include a guide rail 342 provided on the vertical movement plate 332, a horizontal movement plate 341 that moves along the guide rail 342, a lead screw 344 that is screwed to the horizontal movement plate 341, and a driving motor 343 that rotates the lead screw 344 to move the horizontal movement plate 341. With this configuration, in a case where the driving motor 343 operates to rotate the lead screw 344, the horizontal movement plate 341 may move linearly along the guide rail 342 to move the first laser part 321 in a direction parallel to the moving direction of the electrode sheet 10. That is, the horizontal movement part 340 may move the first laser part 321 in the same direction as the moving direction of the electrode sheet 10. Of course, the configuration of the horizontal movement part 340 is not limited to the depicted embodiment, and the horizontal movement part 340 may be configured in any form, such as a linear actuator or an electric stage, as long as the horizontal movement part 340 can move each of the first to third laser parts 321, 322, and 323 in the moving direction of the electrode sheet 10.

The controller 350 may control the driving motor 343 so that a moving speed V2 of the first laser part 321 is the same as a moving speed V1 of the electrode sheet 10. That is, in a case where the first laser part 321 is moved at the same speed while the electrode sheet 10 is moving, notching may be performed in the same state as in a case where the electrode sheet 10 is stopped. Such a configuration may improve the process speed. The controller 350 may control the driving motor 343 so that the first laser part 321 quickly returns to the original position after the notching processing by the first laser part 321 is complete.

The controller 350 may control the first to third laser parts 321, 322, and 323, the vertical movement part 330, and the horizontal movement part 340, as illustrated in FIG. 4.

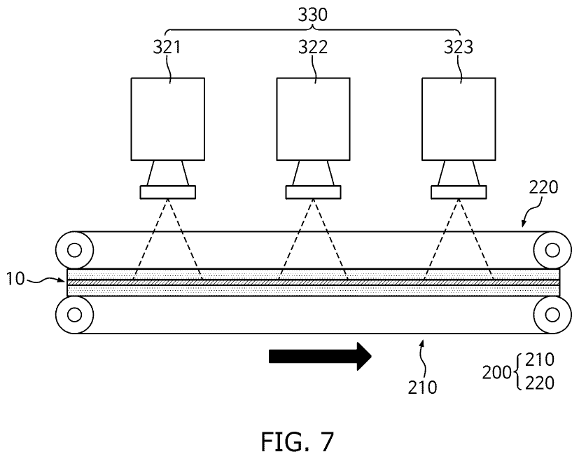

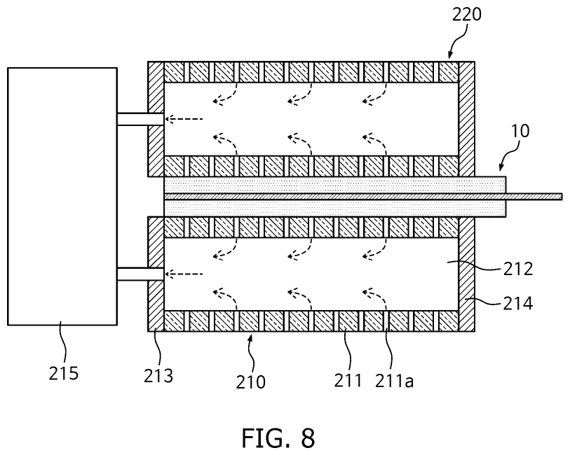

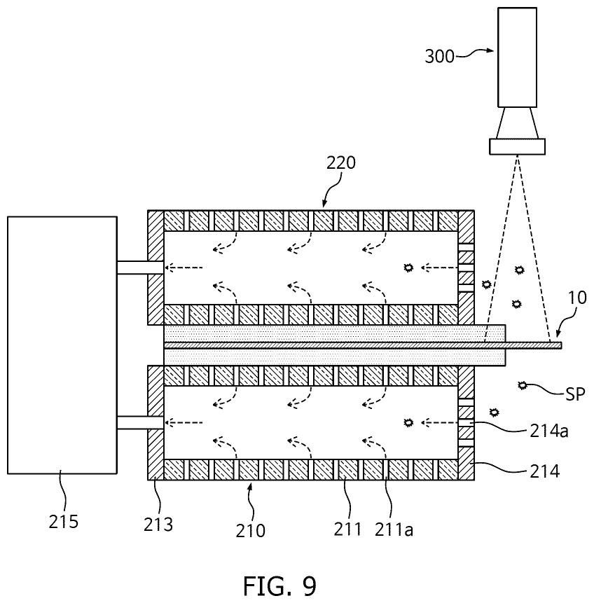

FIG. 7 illustrates another example of a movement part in an apparatus for notching an electrode sheet according to some embodiments of the present disclosure, FIG. 8 illustrates an example of vacuum absorption of an electrode sheet in a movement part according to some embodiments of the present disclosure, and FIG. 9 illustrates an example of suction of spatter in a movement part according to some embodiments of the present disclosure.

Referring to FIGS. 7 to 9, a transport part 200 may include a driving roller and an endless track-shaped conveying belt that is rotated by the driving roller. The electrode sheet 10 may be notched by a plurality of laser parts while being continuously moved by the conveying belt in a state where the electrode sheet 10 is seated on the conveying belt.

In some embodiments, the transport part 200 may include a lower transport part 210 that supports the lower side of the electrode sheet 10 and an upper transport part 220 that supports the upper side of the electrode sheet 10. Accordingly, in a case where the upper transport part 220 and the lower transport part 210 are in close contact with the upper and lower surfaces of the electrode sheet 10 to move the electrode sheet 10, movement of the electrode sheet 10 relative to the transport part 200 may be prevented while the electrode sheet 10 is moved or notched. Accordingly, the laser parts may irradiate laser beams to the same location on the electrode sheet 10, so that the electrode tabs 15 may be manufactured with the same shape and pattern.

The transport part 200 may move the electrode sheet 10 with vacuum. That is, one of the upper transport part 220 and the lower transport part 210 may be configured to perform vacuum absorption, or both the upper transport part 220 and the lower transport part 210 may be configured to perform vacuum absorption.

Referring to FIG. 8, in some embodiments, the lower transport part 210 may include a conveying belt 211 having a plurality of through-holes 211a formed therein, a driving roller 212 that rotates the conveying belt 211, a first cover plate 213 and a second cover plate 214 that are respectively disposed on both sides of the conveying belt 211 to seal the internal space of the conveying belt 211, and a vacuum pump 215 that is connected to the first cover plate 213 and sucks air inside the conveying belt 211 to absorb the electrode sheet 10 to the conveying belt 211. With this configuration, the vacuum pump 215 operates to suck in air inside the conveying belt 211 through the through-holes 211a, the electrode sheet 10 may be vacuum-absorbed onto the conveying belt 211. The upper transport part 220 may also be configured in the same manner as the lower transport part 210 and may perform vacuum absorption.

Referring to FIG. 9, the second cover plate 214 may include a plurality of suction holes 214a for sucking spatter SP generated during the notching of the electrode sheet 10. The second cover plate 214 may be disposed on the side where the laser beam is irradiated onto the electrode sheet 10. In a case where the vacuum pump 215 operates to suck air from inside the conveying belt 211, the air is sucked into the suction holes 214a formed in the second cover plate 214, and spatter around the second cover plate 214 may be sucked into the from inside the conveying belt 211. Accordingly, it is possible to reduce the deterioration in the quality of the electrode due to spatter SP generated and attached to the electrode sheet 10 during the process of notching the electrode sheet 10 by irradiating by a laser beam. That is, the electrode sheet 10 may be steadily moved by vacuum absorption through the upper transport part 220 and the lower transport part 210, and spatter generated during the notching of the electrode sheet 10 may be absorbed and removed.

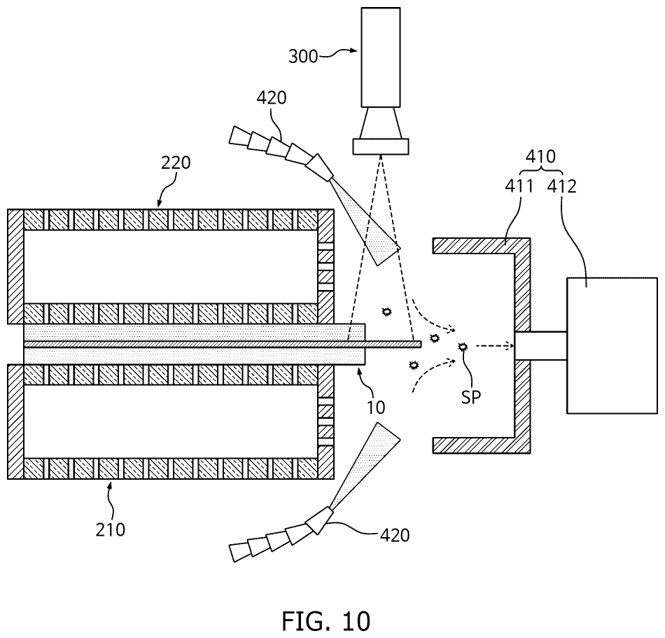

FIG. 10 illustrates an example of removing spatter in an apparatus for notching an electrode sheet according to some embodiments of the present disclosure.

Referring to FIG. 10, the apparatus for notching an electrode sheet according to the present disclosure may include a spatter collection part 410 disposed adjacent to a laser part 300 and configured to suck in spatter SP generated during notching of an electrode sheet 10. The apparatus may also include a blower 420 disposed adjacent to the laser part 300 and configured to generate air flow so as to move the spatter SP generated during notching of the electrode sheet 10 to the spatter collection part 410.

In some embodiments, the spatter collection part 410 may include a cover plate 411 configured to provide a space into which the spatter SP is introduced, and a vacuum pump 412 connected to the cover plate 411 and configured to provide suction force to suck in the spatter SP introduced into the cover plate 411.

The spatter collection part 410 may be formed parallel to the moving direction of the electrode sheet 10, and may be spaced apart from the electrode sheet 10. The spatter collection part 410 may be formed to a length that may cover the entire area where the first to third laser parts perform notching. In addition, the vacuum pump 412 may be connected to the spatter collection part 410 and can provide suction power so that the spatter SP generated during notching of the electrode sheet 10 is introduced into the spatter collection part 410.

The blower 420 may generate air flow by spraying air at a pressure higher than a certain level so that the spatter SP generated during notching of the electrode sheet 10 may be moved to the cover plate 411. The blower 420 may be disposed so that the air sprayed by the blower 420 does not flow directly to the electrode sheet 10. In a case where the air sprayed by the blower 420 is directly sprayed to the electrode sheet 10 at high pressure, the electrode sheet 10 may shake, which may have a negative effect on the notching process. Accordingly, the blower 420 may be disposed to generate air flow around the electrode sheet 10 so that the spatter SP may flow to the cover plate 411. The blowers 420 may be provided at the lower end of the lower transport part 210 and the upper end of the upper transport part 220 to generate air flow at the upper and lower sides of the electrode sheet 10. In a case air flow is only generated on the upper or lower side of the electrode sheet 10, the electrode sheet 10 may be bent to one side. Accordingly, the blowers 420 may be provide air flow on the upper and lower sides of the electrode sheet.

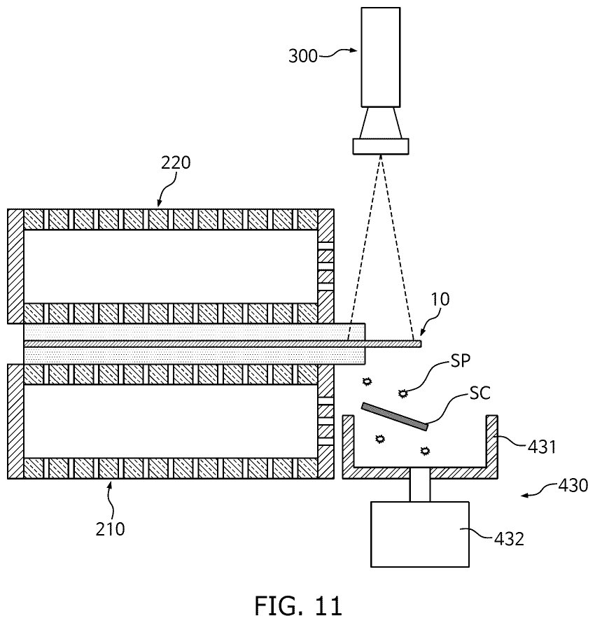

FIG. 11 illustrates an example of recovering scrap in an apparatus for notching an electrode sheet according to some embodiments of the present disclosure.

Referring to FIG. 11, a scrap recovery part 430 according to some embodiments of the present disclosure may include a recovery tray 431 disposed at a position facing a laser unit 300 and configured to recover scrap SC that is dropped in a case where an electrode sheet 10 is notched. A vacuum pump 432 may be connected to the recovery tray 431 and configured to provide suction force to the recovery tray 431.

The recovery tray 431 is disposed below the electrode sheet 10 at a position facing the laser part 300 so that the scrap SC separated from the electrode sheet 10 by the laser part 300 is dropped into the recovery tray 431. The recovery tray 431 may be disposed below a third laser part where the scrap SC is generated. Alternatively, the recovery tray 431 may be disposed below the first to third laser parts so as to collect the spatter SP generated during notching.

The vacuum pump 432 may be connected to the recovery tray 431 and configured to provide suction power so that the scrap SC dropped from the electrode sheet 10 and the spatter SP generated during notching are introduced into the inside of the recovery tray 431.

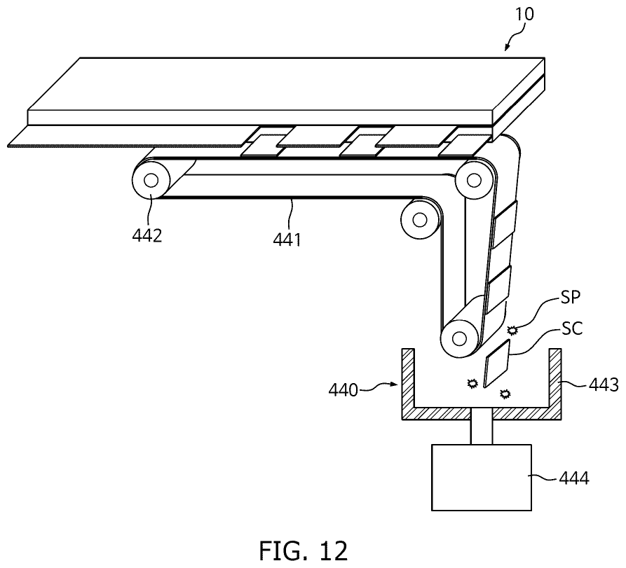

FIG. 12 illustrates another example of recovering scrap in an apparatus for notching an electrode sheet according to some embodiments of the present disclosure.

Referring to FIG. 12, a scrap recovery part 440 according to another embodiment of the present disclosure may include a recovery belt 441 which is disposed at a position facing a laser unit 300 and on which scrap SC generated during notching of an electrode sheet 10 is seated. A driving roller 442 is configured to rotate the recovery belt 441, a recovery tray 443 is configured to recover scrap SC dropped from the recovery belt 441, and a vacuum pump 444 is connected to the recovery tray 443 and configured to provide suction force to the recovery tray 443.

The recovery belt 441 may be configured in the form of an endless track that is rotated by the driving roller 442. The scrap SC may be continuously moved by the recovery belt 441 in a state where the scrap SC is seated on the recovery belt 441 and may be then dropped into the recovery tray 443. Although not illustrated in the drawings, the recovery belt 441 may be configured to vacuum-absorb the scrap SC, like the transport part illustrated in FIG. 8 and described above.

The recovery tray 443 is disposed below the lower end of the recovery belt 441 and is configured to accommodate scrap SC dropped from the recovery belt 441. The vacuum pump 444 may be connected to the recovery tray 443 and configured to provide suction power so that scrap SC and spatter SP dropped from the recovery belt 441 are introduced into the inside of the recovery tray 443.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

### DESCRIPTION OF SOME REFERENCE SYMBOLS

100: apparatus for notching electrode sheet
200: transport part
210: lower transport part
220: upper transport part
300: laser unit
310: base plate
321: first laser part
322: second laser part
323: third laser part
330: vertical movement part
340: horizontal movement part
350: controller
410: spatter collection part
420: blower
430, 440: scrap recovery part

What is claimed is:

1. An apparatus for notching an electrode sheet, the apparatus comprising:
a transport assembly configured to transport an electrode sheet, and
a laser assembly comprising a plurality of laser parts disposed adjacent to the transport part and configured to irradiate laser beams to notch the electrode sheet to thereby form electrode tabs,
wherein the laser parts are spaced apart from each other in a moving direction that the transport assembly is configured to move the electrode sheet, and
wherein each of the laser parts irradiates a laser beam onto a certain area of the electrode sheet in a pattern, with the patterns of the laser beams being the same.

2. The apparatus as claimed in claim 1, wherein the laser parts are configured to irradiate laser beams onto the moving electrode sheet to sequentially notch the electrode sheet in a thickness direction of the electrode sheet.

3. The apparatus as claimed in claim 1, wherein the laser parts comprise:
a first laser part disposed upstream in the moving direction of the electrode sheet and configured to irradiate a laser beam onto the electrode sheet to form a notching pattern;
a second laser part disposed downstream of the first laser part in the moving direction of the electrode sheet and configured to irradiate a laser beam onto the notching pattern to notch a portion of the electrode sheet in a thickness direction of the electrode sheet; and
a third laser part disposed downstream of the second laser part in the moving direction of the electrode sheet and configured to irradiate a laser beam onto the notching pattern to form the electrode tabs.

4. The apparatus as claimed in claim 3, wherein at least one of the first laser part, the second laser part, or the third laser part is spaced at a different height from the electrode sheet than another of the first laser part, the second laser part, and the third laser part.

5. The apparatus as claimed in claim 3, wherein each of the first laser part, the second laser part, and the third laser part is configured to irradiate a pulsed laser beam or a continuous wave laser beam.

6. The apparatus as claimed in claim 3, wherein the electrode sheet is formed by coating a first active material layer and a second active material layer on both sides of a metal substrate with a portion of the electrode sheet remaining uncoated, and
wherein the laser parts sequentially notch the first active material layer, the metal substrate, the uncoated portion, and the second active material layer.

7. The apparatus as claimed in claim 6, wherein the first laser part is configured to form the notching pattern by irradiating a laser beam onto the first active material layer or the uncoated portion and the first active material layer.

8. The apparatus as claimed in claim 7, wherein the second laser part is configured to irradiate a laser beam onto the notching pattern to notch the metal substrate and the uncoated portion after the first active material layer is notched by the first laser part.

9. The apparatus as claimed in claim 8, wherein the third laser part is configured to irradiate a laser beam onto the notching pattern to notch the second active material layer.

10. The apparatus as claimed in claim 9, wherein the first laser part and the third laser part are configured to be positioned at a first height above the electrode sheet, and
wherein the second laser part is configured to be positioned at a second height above the electrode sheet, with the second height being less than the first height.

11. The apparatus as claimed in claim 9, wherein the first laser part and the third laser part are configured to irradiate pulsed laser beams, and
wherein the second laser part is configured to irradiate a continuous wave laser beam.

12. The apparatus as claimed in claim 1, wherein the laser unit comprises:
a base plate; and
a vertical movement part provided on the base plate and configured to move each of the laser parts to adjust gaps between the laser parts and the electrode sheet.

13. The apparatus as claimed in claim 12, wherein the laser unit comprises a horizontal movement part provided between the vertical movement part and the laser parts, the horizontal movement part being configured to move the laser parts in a direction parallel to the moving direction of the electrode sheet.

14. The apparatus as claimed in claim 13, wherein the laser unit comprises a controller configured to control the horizontal movement part to move at least one of the laser parts at a same speed as a moving speed of the electrode sheet.

15. The apparatus as claimed in claim 1, wherein the transport assembly comprises:
a lower transport part configured to support a lower side of the electrode sheet; and
an upper transport part configured to support an upper side of the electrode sheet.

16. The apparatus as claimed in claim 1, wherein the transport assembly comprises:
a conveying belt having a plurality of through-holes formed therein;
a driving roller configured to rotate the conveying belt;
a first cover plate and a second cover plate disposed on opposite sides of the conveying belt and configured to seal an internal space of the conveying belt; and
a vacuum pump connected to the first cover plate and configured to suck in air inside the conveying belt so as to absorb the electrode sheet to the conveying belt.

17. The apparatus as claimed in claim 16, wherein the second cover plate comprises a plurality of suction holes for sucking in spatter generated during the notching of the electrode sheet.

18. The apparatus as claimed in claim 1, further comprising:
a spatter collection part disposed adjacent to the laser assembly and configured to suck in spatter generated during the notching of the electrode sheet; and
a blower disposed adjacent to the laser assembly and configured to generate air flow to move the spatter generated during the notching of the electrode sheet to the spatter collection part.

19. The apparatus as claimed in claim 1, further comprising:
a recovery tray disposed at a position facing the laser assembly and configured to recover scrap dropped during the notching of the electrode sheet; and
a vacuum pump connected to the recovery tray and configured to provide suction force to the recovery tray.

20. The apparatus as claimed in claim 1, further comprising a recovery belt that is disposed at a position facing the laser assembly and on which scrap generated during the notching of the electrode sheet is received;
a driving roller configured to rotate the recovery belt;
a recovery tray configured to recover the scrap dropped from the recovery belt; and
a vacuum pump connected to the recovery tray and configured to provide suction force to the recovery tray.
